(19) United States
(12) Patent Application Publication
(10) Pub. No.: US 2026/0085146 A1
(43) Pub. Date: Mar. 26, 2026

(54) TRIBLOCK POLYMER HAVING A DIENE CENTRAL BLOCK RICH IN ETHYLENE AND TWO TERMINAL BLOCKS, RESPECTIVELY POLYSTYRENE AND POLYETHYLENE

(71) Applicants: COMPAGNIE GENERALE DES ETABLISSEMENTS MICHELIN, Clermont-Ferrand (FR); CENTRE NATIONAL DE LA RECHERCHE SCIENTIFIQUE, PARIS CEDEX 16 (FR); ECOLE SUPÉRIEURE DE CHIMIE PHYSIQUE ELECTRONIQUE DE LYON, VILLEURBANNE CEDEX (FR); UNIVERSITÉ CLAUDE BERNARD LYON 1, VILLEURBANNE CEDEX (FR)

(72) Inventors: Christophe BOISSON, Clermont-Ferrand (FR); Franck D'AGOSTO, Clermont-Ferrand (FR); Charlotte DIRE, Clermont-Ferrand (FR); Séverin DRONET, Clermont-Ferrand (FR); Marvin LANGLAIS, Clermont-Ferrand (FR); Robert NGO, Clermont-Ferrand (FR); François JEAN-BAPTISTE-DIT-DOMINIQUE, Clermont-Ferrand (FR); Damien MONTARNAL, Clermont-Ferrand (FR); Samy ALIOUI, Clermont-Ferrand (FR)

(21) Appl. No.: 19/111,420

(22) PCT Filed: Sep. 12, 2023
(86) PCT No.: PCT/EP2023/075013

§ 371 Date: Mar. 13, 2025

(30) Foreign Application Priority Data
Sep. 15, 2022 (FR) FR2209321

(51) Int. Cl. C08F 295/00

(52) U.S. Cl. CPC C08F 295/00

(57) ABSTRACT

Triblock polymers of formula A-B-C, in which the symbol A represents a polystyrene block, and the symbol B represents a statistical copolymer block with a glass transition temperature of less than-10° C., are provided. The statistical copolymer comprises units of a 1,3-diene and more than 50 mol % of ethylene units. The symbol C represents a polyethylene block with a melting temperature of greater than 90° C. The triblock polymers exhibit good elastic recovery.

### CROSS REFERENCE TO RELATED APPLICATIONS

This U.S. patent application is a national phase entry of PCT Patent Application No. PCT/EP2023/075013, filed Sep. 12, 2023, which claims priority to French Patent Application No. FR 2209321, filed Sep. 15, 2022, the entire contents of which are incorporated herein by reference in their entirety.

### BACKGROUND

### 1. Technical Field

The field of the present invention is that of diene copolymers that are rich in ethylene units.

### 2. Related Art

It has been shown that statistical copolymers based on ethylene and on 1,3-diene that are rich in ethylene units exhibit advantageous stiffness, hysteresis, wear and adhesion properties. Reference may be made, for example, to patent applications WO 2014114607 A1, WO 2016012259 A1 and WO 2016087248 A1.

Another advantage of these copolymers is the use of ethylene which is a common and commercially available monomer, which is accessible via the fossil or biological route. Another advantage of these copolymers is the presence of ethylene units along the polymer backbone, which units are much less sensitive than the diene units to oxidizing or thermal-oxidizing degradation mechanisms, which confers better stability and lifetime on the materials.

The synthesis of diblock polymers in which one of the blocks is a statistical copolymer of ethylene and of a 1,3-diene and the other block is a polystyrene is described in documents WO 2019077235 and WO 2021123590. Subjected to deformation or else repeated cycles of deformation, these diblock polymers exhibit significant residual deformation, which reflects relatively low elastic recovery of the polymer. For uses, it is advantageous to have polymers that have better elastic recovery, i.e. less residual deformation after one or more instances of deformation.

### SUMMARY

The Applicants have discovered that the elastic recovery of diblock polymers having a polystyrene block and a statistical copolymer of ethylene and of a 1,3-diene block is improved by modifying the diblock polymers into triblock polymers comprising a central block which is the statistical copolymer of ethylene and of a 1,3-diene and two terminal blocks, the polystyrene block and a polyethylene block.

Thus, a first subject of the invention is a triblock polymer of formula A-B-C in which the symbol A represents a polystyrene block, the symbol B represents a statistical copolymer block with a glass transition temperature of less than −10° C., the statistical copolymer comprising units of a 1,3-diene and more than 50 mol % of ethylene units, and the symbol C represents a polyethylene block with a melting temperature of greater than 90° C.

A second subject of the invention is a composition which comprises a triblock polymer in accordance with the invention and another component.

Another subject of the invention is a process for synthesizing a triblock polymer of formula A-B-C in accordance with the invention, which process comprises, in the presence of a catalytic system based on at least one metallocene of formula (I) and on an organomagnesium compound of formula (II), the statistical copolymerization of a monomer mixture containing ethylene and a 1,3-diene, followed by the homopolymerization of ethylene,

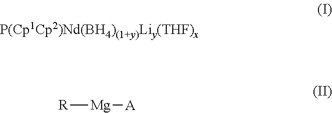

Cp¹ and Cp², which are identical or different, being selected from the group consisting of cyclopentadienyl groups and fluorenyl groups, it being possible for the groups to be substituted or unsubstituted,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms, preferably a methyl,
y, which is an integer, being equal to or greater than 0,
x, which is or not an integer, being equal to or greater than 0,
R comprising a benzene ring of which two carbon atoms are substituted, one of the two is substituted by a methyl, an ethyl or an isopropyl or forms a ring with the carbon atom which is its closest neighbour, the second carbon atom being substituted by a methyl, an ethyl or an isopropyl, the magnesium atom being in ortho position relative to each of said two carbon atoms,
A representing a polystyrene block,
B representing a statistical copolymer block with a glass transition temperature of less than −10° C., the statistical copolymer comprising units of a 1,3-diene and more than 50 mol % of ethylene units,
C representing a polyethylene block with a melting temperature of greater than 90° C.

### DETAILED DESCRIPTION

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

Unless otherwise indicated, the contents of the units resulting from the insertion of a monomer into a polymer are expressed as molar percentage relative to the total monomer units that constitute the polymer.

The compounds mentioned in the description may be of fossil origin or be biobased. In the latter case, they may be partially or completely derived from biomass or obtained from renewable raw materials derived from biomass. In the same way, the compounds mentioned may also originate from the recycling of already-used materials, i.e. they may partially or completely result from a recycling process, or else be obtained from raw materials which themselves result from a recycling process.

The block represented by the symbol B in the formula A-B-C and referred to hereinafter as “the central block” represents a block which is a statistical copolymer containing ethylene units and units of a 1,3-diene, which means that the constituent monomer units of the central block are statistically distributed in the central block. The two other blocks represented by A and C are homopolymers, respectively a polystyrene and a polyethylene.

In a known manner, “ethylene unit” is understood to mean a unit which has the —(CH₂—CH₂)-subunit. The ethylene units present in block B, referred to as the central block, represent more than 50 mol % of the monomer units which constitute the central block. In the present application, the content of ethylene units in the central block, i.e. the number of moles of ethylene units in the central block, is expressed as molar percentage relative to the number of moles of monomer units constituting the central block.

According to any one of the embodiments of the invention, the central block is preferably a statistical copolymer of ethylene and of a 1,3-diene, in which case the monomer units of the central block are those resulting from the copolymerization of ethylene and of the 1,3-diene and are distributed statistically in the central block.

According to the invention, the 1,3-diene of which the monomer units constitute the central block is just one compound, i.e. just one 1,3-diene, or is a mixture of 1,3-dienes which differ from each other by the chemical structure. The 1,3-diene is preferably 1,3-butadiene or isoprene or else a mixture of 1,3-dienes of which one is 1,3-butadiene. The 1,3-diene is more preferentially 1,3-butadiene. Very preferentially, the central block is a statistical copolymer of ethylene and of 1,3-butadiene.

In a known manner, a 1,3-diene may be inserted into a growing polymer chain by a 1,4 or 2,1 insertion or else 3,4 insertion in the case of substituted diene such as isoprene to give rise to the formation of the 1,3-diene unit of 1,4 configuration, the 1,3-diene unit of 1,2 configuration or of 3,4 configuration, respectively. Preferably, the units of the 1,3-diene in the 1,2 configuration and the units of the 1,3-diene in the 3,4 configuration represent more than 50 mol % of the units of the 1,3-diene.

According to one embodiment of the invention, the central block contains units of the 1,3-diene of 1,4 configuration, preferably trans-1,4 configuration. Preferably, the units of the 1,3-diene of trans-1,4 configuration represent more than 50 mol % of the units of the 1,3-diene of 1,4 configuration. More preferentially, the units of the 1,3-diene of trans-1,4 configuration represent 100 mol % of the units of the 1,3-diene of 1,4 configuration.

According to a particularly preferential embodiment of the invention, the central block contains units of the 1,3-diene which contain more than 50 mol % of units of 1,2 or 3,4 configuration, the balance to 100% of the units of the 1,3-diene being units of trans-1,4 configuration.

According to another particularly preferential embodiment of the invention, in particular when the 1,3-diene is 1,3-butadiene or a mixture of 1,3-dienes of which one is 1,3-butadiene, the central block also contains 1,2-cyclohexane units or 1,4-cyclohexane units, preferably 1,2-cyclohexane units. The presence of these cyclic structures in the central block results from a very particular insertion of the ethylene and 1,3-butadiene during their copolymerization. The mechanism for obtaining such a microstructure is described, for example, in the document Macromolecules, 2009, 42, 3774-3779. The content of 1,2-cyclohexane unit and of 1,4-cyclohexane unit in the central block varies according to the respective contents of ethylene and of 1,3-butadiene in the central block. Preferentially, it is less than or equal to 15%, this molar percentage being expressed relative to the number of moles of monomer units constituting the central block. The central block generally contains less than 10 mol % of 1,2-cyclohexane unit and of 1,4-cyclohexane unit for the highest contents of ethylene in the central block, and may contain more than 10% for the lowest contents of ethylene in the central block, for example up to 15%, this percentage being expressed relative to the number of moles of monomer units constituting the central block. The 1,2-cyclohexane unit corresponds to the following formula.

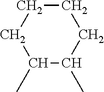

As the stiffness of the triblock polymer increases with the content of ethylene units in the central block, a triblock polymer with a particularly high content of ethylene units in the central block may be desired for applications where high stiffness of the material is required. Preferably, the ethylene units in the central block represent more than 60 mol % of the units which constitute the central block, in which case the central block contains more than 60 mol % of ethylene units. More preferentially, the ethylene units in the central block represent at least 70 mol % of the units which constitute the central block, in which case the central block contains at least 70 mol % of ethylene units.

According to a particular embodiment of the invention, the ethylene units in the central block represent less than 90 mol % of the units which constitute the central block, in which case the central block contains less than 90 mol % of ethylene units.

According to another particular embodiment of the invention, the ethylene units in the central block represent at most 85 mol % of the units which constitute the central block, in which case the central block contains at most 85 mol % of ethylene units.

The central block has a glass transition temperature (Tg) of less than −10° C., preferably of between −90° C. and −10° C. More preferentially, the glass transition temperature of the central block is between −70° C. and −20° C., advantageously between −50° C. and −20° C. In a known manner, the glass transition temperature of the central block may for example be adjusted with the chemical structure of the 1,3-diene, with the respective content of ethylene units and of the units of the 1,3-diene in the central block.

The central block has a number-average molar mass preferentially of greater than 20 000 g/mol, more preferentially of greater than or equal to 50 000 g/mol.

The central block has a number-average molar mass of preferentially less than or equal to 150 000 g/mol.

According to a preferential embodiment of the invention, the central block has a number-average molar mass ranging from 50 000 g/mol to 150 000 g/mol.

According to another preferential embodiment of the invention, the central block has a number-average molar mass ranging from 50 000 g/mol to 100 000 g/mol.

The block represented by the symbol A in the formula A-B-C has the essential feature of being a polystyrene. Preferably, A represents a linear polystyrene. Preferably, the polystyrene block is an atactic polystyrene.

The polystyrene block has a number-average molar mass preferentially of greater than or equal to 5000 g/mol. Preferably, the polystyrene block has a number-average molar mass ranging from 5000 g/mol to 100 000 g/mol, in particular ranging from 5000 g/mol to 65 000 g/mol. More preferentially, the Mn of the polystyrene block is greater than or equal to 10 000 g/mol, in particular ranging from 10 000 g/mol to 100 000 g/mol, more particularly ranging from 10 000 g/mol to 65 000 g/mol. The polystyrene block typically has a glass transition temperature of greater than 80° C., preferentially greater than or equal to 90° C., more preferentially greater than or equal to 100° C. Since the glass transition of the polystyrene block is in the same temperature range as the melting of the polyethylene block, the glass transition temperature of the polystyrene block cannot be determined by analysis (such as differential scanning calorimetry, DSC) of the triblock polymer. It can be determined during the synthesis of the triblock polymer before the formation of the polyethylene block.

The block represented by the symbol C in the formula A-B-C has the essential feature of being a polyethylene with a melting temperature of greater than 90° C., in particular greater than 90° C. and less than 140° C. The melting temperature of the polyethylene block is more preferentially greater than 100° C. and less than 130° C. Preferably, C represents a linear polyethylene. The polyethylene block preferentially has a number-average molar mass of greater than or equal to 2000 g/mol and less than or equal to 12 000 g/mol. The portion of polystyrene block and of polyethylene block in the triblock polymer represents preferentially less than 50% by mass of the mass of the triblock polymer, more preferentially from 15% to 40% by mass of the mass of the triblock polymer.

The triblock polymer has a number-average molar mass (Mn) preferentially of between 30 000 g/mol and 200 000 g/mol, more preferentially ranging from 50 000 g/mol to 150 000 g/mol, in particular ranging from 50 000 g/mol to 100 000 g/mol.

The triblock polymer is most particularly a thermoplastic elastomer in which the polystyrene block and the polyethylene block constitute the rigid phases of the triblock polymer, and the central block constitutes the flexible phase of the triblock polymer.

The triblock polymer in accordance with the invention can be prepared according to a process which comprises the statistical copolymerization of a monomer mixture containing ethylene and the 1,3-diene, and then the subsequent polymerization of ethylene.

The catalytic system (or catalytic composition) used in the statistical copolymerization of the monomer mixture and in the homopolymerization of ethylene is based on at least one metallocene of formula (I) and on an organomagnesium compound of formula (II)

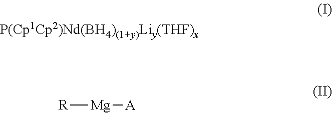

Cp¹ and Cp², which are identical or different, being selected from the group consisting of cyclopentadienyl groups and fluorenyl groups, it being possible for the groups to be substituted or unsubstituted,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms, preferably a methyl,
y, which is an integer, being equal to or greater than 0,
x, which is or not an integer, being equal to or greater than 0, the symbol A representing a polystyrene chain which is identical in every respect to the styrene block of formula A-B-C,
R comprising a benzene ring of which two carbon atoms are substituted, one of the two is substituted by a methyl, an ethyl or an isopropyl or forms a ring with the carbon atom which is its closest neighbour, the second carbon atom being substituted by a methyl, an ethyl or an isopropyl, the magnesium atom being in ortho position relative to each of said two carbon atoms.

In formula (I), the neodymium atom is connected to a ligand molecule consisting of the two groups Cp¹ and Cp² which are connected together by the bridge P. Preferably, the symbol P, denoted by the term bridge, corresponds to the formula ZR¹R², Z representing a silicon atom, R¹ and R², which are identical or different, representing an alkyl group comprising from 1 to 20 carbon atoms. More preferentially, the bridge P is of formula SiR¹R², R¹ and R² being identical and as defined previously. Even more preferentially, P corresponds to the formula SiMe₂.

As substituted cyclopentadienyl and fluorenyl groups, mention may be made of those substituted by alkyl groups having 1 to 6 carbon atoms or by aryl groups having 6 to 12 carbon atoms or else by trialkylsilyl groups such as SiMe₃. The choice of the alkyl, aryl and trialkylsilyl groups is also guided by the accessibility to the corresponding molecules, which are the substituted cyclopentadienes and fluorenes, because the latter are commercially available or can be easily synthesized.

As substituted cyclopentadienyl groups, mention may be made of those substituted either in the 2 (or 5) position or in the 3 (or 4) position, particularly those substituted in the 2 position, more particularly the tetramethylcyclopentadienyl group. In the present application, in the case of the cyclopentadienyl group, the 2 (or 5) position denotes the position of the carbon atom which is adjacent to the carbon atom to which the bridge P is attached, as is represented in the diagram below.

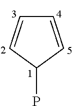

As substituted fluorenyl groups, mention may be made of those substituted in the 2, 7, 3 or 6 position, particularly 2,7-di(tert-butyl) fluorenyl and 3,6-di(tert-butyl) fluorenyl groups. The 2, 3, 6 and 7 positions respectively denote the positions of the carbon atoms of the rings as represented in the diagram below, position 9 corresponding to the carbon atom to which the bridge P is attached.

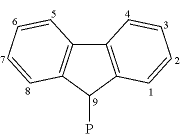

Preferably, Cp¹ and Cp² are identical and are selected from the group consisting of substituted fluorenyl groups and the fluorenyl group. Advantageously, in formula (I) Cp¹ and Cp² each represent a substituted fluorenyl group or a fluorenyl group, preferably a fluorenyl group. The fluorenyl group is of formula C₁₃H₈. Preferably, the metallocene is of formula (Ia), (Ib), (Ic), (Id) or (le), in which the symbol Flu represents the fluorenyl group of formula C₁₃H₈.

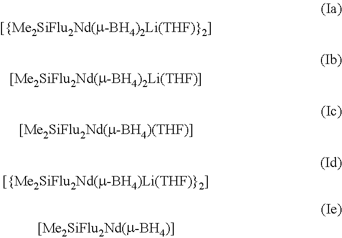

The metallocene used for preparing the catalytic system may be in the form of a crystalline or non-crystalline powder, or else in the form of single crystals. The metallocene may be in a monomer or dimer form, these forms depending on the method of preparation of the metallocene, as is described, for example, in patent application WO 2007054224. The metallocene can be prepared conventionally by a process analogous to that described in patent application WO 2007054224, notably by reaction, under inert and anhydrous conditions, of the salt of an alkali metal of the ligand with a rare earth metal borohydride in a suitable solvent, such as an ether, for example diethyl ether or tetrahydrofuran, or any other solvent known to those skilled in the art. After reaction, the metallocene is separated from the reaction byproducts by techniques known to those skilled in the art, such as filtration or precipitation from a second solvent. The metallocene is finally dried and isolated in solid form.

Like any synthesis carried out in the presence of an organometallic compound, the synthesis of the metallocene takes place under anhydrous conditions under an inert atmosphere. Typically, the reactions are performed starting with anhydrous solvents and compounds under anhydrous nitrogen or argon.

The organomagnesium compound of formula (II) is used in the catalytic system as a cocatalyst. Preferably, the two substituents of said two carbon atoms with respect to which the magnesium atom is in ortho position are identical. More preferentially, they are methyls or ethyls. Advantageously, they are methyls.

Preferably, the organomagnesium compound of formula (II) corresponds to formula (II-1) in which A represents the polystyrene chain, R₁ and R₅, which are identical or different, represent a methyl or an ethyl and R₂, R₃ and R₄, which are identical or different, represent a hydrogen atom or an alkyl. Preferably, R₁ and R₅ represent a methyl. Preferably, R₂ and R₄ represent a hydrogen atom.

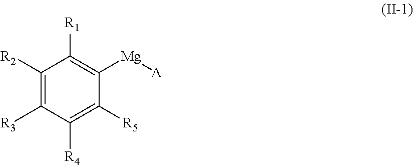

According to a preferential variant, R₁, R₃ and R₅ are identical. According to a more preferential variant, R₂ and R₄ represent a hydrogen and R₁, R₃ and R₅ are identical. In a more preferential variant, R₂ and R₄ represent a hydrogen and R₁, R₃ and R₅ represent a methyl.

The organomagnesium compound of formula (II) can be prepared by a process which comprises the reaction of a living anionic polystyrene ALi with an organomagnesium halide of formula R—Mg—X, R being defined as in formula (II), A representing the polystyrene block, X being a halogen atom, preferentially a chlorine or bromine atom, more preferentially a bromine atom, the symbol Li representing, in a known manner, the lithium atom. In a known manner, “anionic polystyrene” is understood to mean a polystyrene that is prepared by anionic polymerization. Also in a known manner, “living polystyrene” is understood to mean a polystyrene having polymer chains that have a reactive centre with respect to the polymerization, typically a carbon-lithium bond, in particular at the polymer chain end.

The living anionic polystyrene is conventionally obtained by anionic polymerization of the styrene in a solvent, referred to as the polymerization solvent. The polymerization solvent may be any hydrocarbon-based solvent known for use in the polymerization of styrene. The polymerization solvent is preferentially a hydrocarbon-based solvent, more preferentially cyclohexane, methylcyclohexane or toluene.

The ratio between the amount of solvent and the amount of styrene of use for the formation of the living anionic polystyrene is chosen by those skilled in the art according to the desired viscosity of the polymer solution of the living polystyrene. This viscosity depends not only on the concentration of the polymer solution, but also on many other factors such as the length of the polymer chains, the intermolecular interactions between the living polystyrene chains, the complexing power of the solvent, and the temperature of the polymer solution. Consequently, those skilled in the art will adjust the amount of solvent on a case-by-case basis.

To initiate the polymerization of styrene, use may be made of the compounds that are well known to those skilled in the art as initiators of the anionic polymerization of styrene. For example, the initiator is a compound having a carbon-lithium bond. As initiator, mention may be made of organolithium compounds, such as n-butyllithium, sec-butyllithium and tert-butyllithium. The initiator is used in an amount chosen as a function of the desired chain length of the living polystyrene.

The polymerization temperature for forming the living polystyrene may vary to a large extent. Traditionally, it varies within a range extending from −20° C. to 100° C., preferentially from 20° C. to 70° C.

To prepare the organomagnesium compound of formula (II), the reaction of the living anionic polystyrene with the organomagnesium halide can be performed by adding a solution of the living anionic polystyrene to a solution of the organomagnesium halide R—Mg—X, but it is preferentially performed by adding a solution of the organomagnesium halide R—Mg—X to a solution of the living anionic polystyrene. The solution of the living anionic polystyrene is generally a solution in a hydrocarbon-based solvent, preferably the polymerization solvent used for the synthesis of the living anionic polystyrene. The solution of the organomagnesium halide R—Mg—X is generally a solution in an ether, preferably diethyl ether or dibutyl ether. The concentration of the living anionic polystyrene is preferentially from 0.01 to 1 mol of lithium equivalent/l, more preferentially from 0.05 to 0.2 mol of lithium equivalent/l, and that of the solution of the organomagnesium compound R—Mg—X is preferentially from 1 to 5 mol/l, more preferentially from 2 to 3 mol/l.

The reaction between the living anionic polystyrene and organomagnesium halide R—Mg—X is typically performed at a temperature ranging from 0° C. to 60° C. The contacting is preferably carried out at a temperature of between 0° C. and 23° C.

Like any synthesis carried out in the presence of organometallic compounds, the contacting and the reaction take place under anhydrous conditions under an inert atmosphere. Typically, the solvents and the solutions are used under anhydrous nitrogen or argon. The various steps of the process are generally performed with stirring.

Once the organomagnesium compound of formula (II) has been formed, the solution of the organomagnesium compound of formula (II) is typically stored, before its use as cocatalyst of the catalytic system, in sealed containers, for example capped bottles, at a temperature of between-25° C. and 23° C., under an inert and anhydrous atmosphere.

The catalytic system can be prepared traditionally by a process analogous to that described in patent application WO 2007054224 or WO 2007054223. For example, the cocatalyst and the metallocene can be reacted in a hydrocarbon-based solvent typically at a temperature ranging from 20° C. to 80° C. for a period of between 5 and 60 minutes. The amounts of cocatalyst and of metallocene reacted are such that the ratio between the number of moles of Mg of the cocatalyst and the number of moles of rare earth metal of the metallocene varies preferably from 1 to 100, more preferentially from 1 to less than 10. The range of values extending from 1 to less than 10 is notably more favourable for obtaining polymers of high molar masses. The catalytic system is generally prepared in an aliphatic hydrocarbon-based solvent such as methylcyclohexane, or an aromatic hydrocarbon-based solvent such as toluene. Generally, after its synthesis, the catalytic system is used as is in the process for synthesizing the polymer in accordance with the invention.

The catalytic system is generally in the form of a solution in a hydrocarbon-based solvent. The hydrocarbon-based solvent may be aliphatic, such as methylcyclohexane, or aromatic, such as toluene. The hydrocarbon-based solvent is preferably aliphatic, more preferentially methylcyclohexane. Generally, the catalytic system is stored in the form of a solution in the hydrocarbon-based solvent before being used in polymerization. This may then be referred to as a catalytic solution which comprises the catalytic system and the hydrocarbon-based solvent. The concentration of the catalytic solution is typically defined by the content of metallocene metal in the solution. The concentration of metallocene metal has a value ranging preferentially from 0.0001 to 0.2 mol/l, more preferentially from 0.001 to 0.03 mol/l.

Like any synthesis carried out in the presence of an organometallic compound, the synthesis of the catalytic system takes place under anhydrous conditions under an inert atmosphere. Typically, the reactions are performed starting with anhydrous solvents and compounds under anhydrous nitrogen or argon.

The catalytic system is used for the two polymerization steps, which are the statistical copolymerization of the monomer mixture and the subsequent homopolymerization of ethylene. The two steps of polymerization of the monomer mixture are preferably performed in solution, continuously or batchwise, in a reactor which is advantageously stirred. The polymerization solvent may be an aromatic or aliphatic hydrocarbon-based solvent. Examples of polymerization solvents that may be mentioned include toluene and methylcyclohexane.

The catalytic system is generally introduced into the reactor containing the polymerization solvent and the monomer mixture containing ethylene and a 1,3-diene. To achieve the desired macrostructure of the central block, those skilled in the art will adapt the polymerization conditions, notably the molar ratio of the organomagnesium compound to the metal Nd constituting the metallocene. The molar ratio may reach the value of 100, knowing that a molar ratio of less than 10 is more favourable for obtaining polymers with high molar masses.

The preparation of the central block is carried out by statistical copolymerization of the monomer mixture containing ethylene and a 1,3-diene. Preferably, ethylene and 1,3-diene are added continuously to the polymerization reactor, in which case the polymerization reactor is a fed reactor.

This embodiment is most particularly suited for statistical incorporation of ethylene and of the 1,3-diene.

The polymerization temperature generally varies within a range extending from 30° C. to 160° C., preferentially from 30° C. to 120° C. During the preparation of the central block, the temperature of the reaction medium is advantageously kept constant during the copolymerization and the total pressure in the reactor is also advantageously kept constant. The preparation of the central block is completed by cutting off the monomer supply, notably by a drop in the pressure of the reactor, preferably to about 3 bar.

The preparation of the polyethylene block by the subsequent polymerization of ethylene is continued by applying an ethylene pressure in the reactor, the ethylene pressure being kept constant until the desired consumption of ethylene to achieve the desired number-average molar mass of the polyethylene block. The polymerization temperature of the ethylene is preferably carried out at a temperature identical to that of the preparation of the central block. The polymerization temperature for the preparation of the polyethylene block generally varies within a range extending from 30° C. to 160° C., preferentially from 30° C. to 120° C. The pressure for the preparation of the polyethylene block generally varies within a range extending from 1 bar to 150 bar and preferentially from 1 bar to 10 bar. The synthesis of the polyethylene block is completed when the polyethylene block reaches the desired number-average molar mass.

The polymerization can be stopped by cooling the polymerization medium or by adding an alcohol, preferentially an alcohol containing 1 to 3 carbon atoms, for example ethanol. The triblock polymer can be recovered according to conventional techniques known to those skilled in the art such as, for example, by precipitation, by evaporation of the solvent under reduced pressure or by steam stripping.

Alternatively, the triblock polymer can be prepared by another process that differs from that described in that the cocatalyst is not the organomagnesium compound of formula (II) but the living anionic polystyrene ALi, and that the molar ratio between the number of moles of living polymer and the number of moles of Nd atoms in the metallocene varies within a range extending from 0.8 to 1.2.

The triblock polymer may be used in a composition, another subject of the invention, which typically comprises another component. The other component may be a filler such as a carbon black or a silica, a plasticizer such as an oil, a crosslinking agent such as sulfur or a peroxide, an antioxidant, or a polymer, notably an elastomer. The composition may be a rubber composition.

In summary, the invention is advantageously implemented according to any one of the following embodiments 1 to 39:

Embodiment 1: Triblock polymer of formula A-B-C in which the symbol A represents a polystyrene block, the symbol B represents a statistical copolymer block with a glass transition temperature of less than −10° C., the statistical copolymer comprising units of a 1,3-diene and more than 50 mol % of ethylene units, and the symbol C represents a polyethylene block with a melting temperature of greater than 90° C.

Embodiment 2: Triblock polymer according to embodiment 1, in which the statistical copolymer block is a statistical copolymer of ethylene and of a 1,3-diene.

Embodiment 3: Triblock polymer according to embodiment 1 or 2, in which the statistical copolymer block contains more than 60 mol % of ethylene units.

Embodiment 4: Triblock polymer according to any one of embodiments 1 to 3, in which the statistical copolymer block contains at least 70 mol % of ethylene units.

Embodiment 5: Triblock polymer according to any one of embodiments 1 to 4, in which the statistical copolymer block contains less than 90 mol % of ethylene units.

Embodiment 6: Triblock polymer according to any one of embodiments 1 to 5, in which the statistical copolymer block contains at most 85 mol % of ethylene units.

Embodiment 7: Triblock polymer according to any one of embodiments 1 to 6, in which the portion of polystyrene block and of polyethylene block in the triblock polymer represents less than 50% by mass of the mass of the triblock polymer.

Embodiment 8: Triblock polymer according to any one of embodiments 1 to 7, in which the portion of polystyrene block and of polyethylene block in the triblock polymer represents from 15% to 40% by mass of the mass of the triblock polymer.

Embodiment 9: Triblock polymer according to any one of embodiments 1 to 8, in which the statistical copolymer block has a glass transition temperature of between −90° C. and −10° C.

Embodiment 10: Triblock polymer according to any one of embodiments 1 to 9, in which the statistical copolymer block has a glass transition temperature of between −70° C. and −20° C.

Embodiment 11: Triblock polymer according to any one of embodiments 1 to 10, in which the statistical copolymer block has a glass transition temperature of between −50° C. and −20° C.

Embodiment 12: Triblock polymer according to any one of embodiments 1 to 11, in which the statistical copolymer block has a number-average molar mass of greater than 20 000 g/mol.

Embodiment 13: Triblock polymer according to any one of embodiments 1 to 12, in which the statistical copolymer block has a number-average molar mass of greater than or equal to 50 000 g/mol.

Embodiment 14: Triblock polymer according to any one of embodiments 1 to 13, in which the statistical copolymer block has a number-average molar mass of greater than or equal to 150 000 g/mol.

Embodiment 15: Triblock polymer according to any one of embodiments 1 to 14, in which the statistical copolymer block has a number-average molar mass ranging from 50 000 g/mol to 150 000 g/mol.

Embodiment 16: Triblock polymer according to any one of embodiments 1 to 15, in which the statistical copolymer block has a number-average molar mass ranging from 50 000 g/mol to 100 000 g/mol.

Embodiment 17: Triblock polymer according to any one of embodiments 1 to 16, in which the 1,3-diene is 1,3-butadiene or isoprene.

Embodiment 18: Triblock polymer according to any one of embodiments 1 to 16, in which the 1,3-diene is 1,3-butadiene.

Embodiment 19: Triblock polymer according to any one of embodiments 1 to 16, in which the 1,3-diene is a mixture of 1,3-dienes of which one is 1,3-butadiene.

Embodiment 20: Triblock polymer according to embodiment 18 or 19, in which the statistical copolymer block contains 1,2-cyclohexane units or 1,4-cyclohexane units, preferably 1,2-cyclohexane units.

Embodiment 21: Triblock polymer according to embodiment 20, in which the content of 1,2-cyclohexane unit and of 1,4-cyclohexane unit in the statistical copolymer block is less than or equal to 15%, this molar percentage being expressed relative to the number of moles of monomer units constituting the statistical copolymer block.

Embodiment 22: Triblock polymer according to any one of embodiments 1 to 21, in which the units of the 1,3-diene in the 1,2 configuration and the units of the 1,3-diene in the 3,4 configuration represent more than 50 mol % of the units of the 1,3-diene.

Embodiment 23: Triblock polymer according to any one of embodiments 1 to 22, in which the statistical copolymer block contains units of the 1,3-diene which contain more than 50 mol % of units of 1,2 or 3,4 configuration, the balance to 100% of the units of the 1,3-diene being units of trans-1,4 configuration.

Embodiment 24: Triblock polymer according to any one of embodiments 1 to 23, in which the polystyrene block has a number-average molar mass of greater than or equal to 5000 g/mol.

Embodiment 25: Triblock polymer according to any one of embodiments 1 to 24, in which the polystyrene block has a number-average molar mass ranging from 5000 g/mol to 100 000 g/mol.

Embodiment 26: Triblock polymer according to any one of embodiments 1 to 25, in which the polystyrene block has a number-average molar mass ranging from 5000 g/mol to 65 000 g/mol.

Embodiment 27: Triblock polymer according to any one of embodiments 1 to 26, in which the polystyrene block has a number-average molar mass of greater than or equal to 10 000 g/mol.

Embodiment 28: Triblock polymer according to any one of embodiments 1 to 27, in which the polystyrene block has a number-average molar mass ranging from 10 000 g/mol to 100 000 g/mol.

Embodiment 29: Triblock polymer according to any one of embodiments 1 to 28, in which the polystyrene block has a number-average molar mass ranging from 10 000 g/mol to 65 000 g/mol.

Embodiment 30: Triblock polymer according to any one of embodiments 1 to 29, in which the polystyrene block is a linear polystyrene.

Embodiment 31: Triblock polymer according to any one of embodiments 1 to 30, in which the polystyrene block is an atactic polystyrene.

Embodiment 32: Triblock polymer according to any one of embodiments 1 to 31, in which the polyethylene block has a number-average molar mass of greater than or equal to 2000 g/mol and less than or equal to 12 000 g/mol.

Embodiment 33: Triblock polymer according to any one of embodiments 1 to 32, in which the melting temperature of the polyethylene block is greater than 100° C. and less than 130° C.

Embodiment 34: Triblock polymer according to any one of embodiments 1 to 33, which triblock polymer has a number-average molar mass of between 30 000 g/mol and 200 000 g/mol.

Embodiment 35: Triblock polymer according to any one of embodiments 1 to 34, which triblock polymer has a number-average molar mass ranging from 50 000 g/mol to 150 000 g/mol.

Embodiment 36: Triblock polymer according to any one of embodiments 1 to 35, which triblock polymer has a number-average molar mass ranging from 50 000 g/mol to 100 000 g/mol.

Embodiment 37: Triblock polymer according to any one of embodiments 1 to 36, which triblock polymer is a thermoplastic elastomer.

Embodiment 38: Composition which comprises a triblock polymer defined in any one of embodiments 1 to 37 and another component.

Embodiment 39: Process for synthesizing a triblock polymer of formula A-B-C defined in any one of embodiments 1 to 37, which process comprises, in the presence of a catalytic system based on at least one metallocene of formula (I) and on an organomagnesium compound of formula (II), the statistical copolymerization of a monomer mixture containing ethylene and a 1,3-diene, followed by the homopolymerization of ethylene,

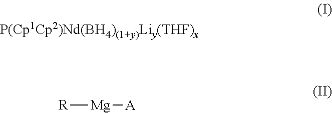

Cp¹ and Cp², which are identical or different, being selected from the group consisting of cyclopentadienyl groups and fluorenyl groups, it being possible for the groups to be substituted or unsubstituted,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms, preferably a methyl,
y, which is an integer, being equal to or greater than 0,
x, which is or not an integer, being equal to or greater than 0,
R comprising a benzene ring of which two carbon atoms are substituted, one of the two is substituted by a methyl, an ethyl or an isopropyl or forms a ring with the carbon atom which is its closest neighbour, the second carbon atom being substituted by a methyl, an ethyl or an isopropyl, the magnesium atom being in ortho position relative to each of said two carbon atoms,
A representing a polystyrene block,
B representing a statistical copolymer block with a glass transition temperature of less than −10° C., the statistical copolymer comprising units of a 1,3-diene and more than 50 mol % of ethylene units,
C representing a polyethylene block with a melting temperature of greater than 90° C.

The abovementioned features of the present invention, and also others, will be better understood on reading the following description of several exemplary embodiments of the invention, which are given by way of nonlimiting illustration.

### Examples

### 1-1-Size-Exclusion Chromatography (SEC-THF):

Size-exclusion chromatography analyses of polystyrene homopolymers and of PS-b-EBR diblock polymers were carried out using a Viscotek apparatus (Malvern Instruments) equipped with a guard column and 3 columns (SDVB, 5 μm, 330×7.5 mm, Polymer Standards) and 3 detectors (refractometer, viscometer and light scattering). The samples are prepared at a concentration of 3-4 mg ml-1 and filtered through a 0.45 μm PTFE membrane and the analyses are carried out at 40° C. in stabilized THF at a flow rate of 1 ml min⁻¹. The data are acquired and processed using the OmniSEC software. The number-average molar masses (Mn) of the copolymers are determined by means of a conventional calibration obtained from polystyrene standards (800-2 500 000 g mol⁻¹), Polymer Standard Service (Mainz) using the refractometer detector. The dispersity D (D=Mw/Mn) is also determined.

The Mn of the polystyrene block of the triblock polymer can also be determined by the size-exclusion chromatography analysis method during the synthesis of the triblock before the formation of the central block and of the polyethylene block, for example after deactivation of the chains of the living polystyrene for example by adding methanol or ethanol to the polymer solution of the living polystyrene before adding the monomer mixture containing ethylene and a 1,3-diene.

The Mn of the two-block polymer which is formed as intermediate product in the synthesis of the triblock polymer and which contains, as first block, the polystyrene block of the triblock and, as second block, the central block of the triblock, can also be determined by the size-exclusion chromatography analysis method during the synthesis of the triblock before the formation of the polyethylene block, for example after deactivation of the polymer chains of the two-block polymer. The Mn of the central block of the triblock polymer can be determined from the Mn of the polystyrene block and the Mn of the two-block polymer that have previously been determined.

### 1-2-Size-Exclusion Chromatography of the Triblock Polymers (SEC-HT):

High-temperature size-exclusion chromatography (HT-SEC or SEC-HT) analyses were carried out using a Viscotek apparatus (Malvern Instruments) equipped with 3 columns (PLgel Olexis 300 mm×7 mm I. D., Agilent Technologies) and 3 detectors (differential refractometer and viscometer, and light scattering). 200 μl of a solution of the sample at a concentration of 3 mg ml-1 were eluted in 1,2,4-trichlorobenzene using a flow rate of 1 ml min 1 at 150° C. The mobile phase was stabilized with 2,6-di(tert-butyl)-4-methylphenol (400 mg 1-1). The OmniSEC software was used to acquire and analyse the data. The number-average (Mn) and mass-average (Mw) molar masses of the synthesized triblock polymers were calculated using a universal calibration curve calibrated from standard polystyrenes (peak molar masses Mp: 672 to 12 000 000 g mol⁻¹) from Polymer Standard Service (Mainz) using refractometer and viscometer detectors. The dispersity D (D=Mw/Mn) is also calculated.

### 2—Differential Scanning Calorimetry (DSC):

DSC analyses are performed on a DSC 3+ apparatus (Mettler Toledo) with sealed aluminium crucibles (40 μl) and under a nitrogen stream (30 ml min⁻¹). The temperature programmes are as follows:

2-1—The thermograms of the polystyrene homopolymers (Example 1 and 2) are obtained according to the following programme: •step 1: ramp from 25° C. to 140° C. (10° C. min⁻¹), •step 2: ramp from 140° C. to 25° C. (10° C. min⁻¹), •step 3: ramp from 25° C. to 140° C. (10° C. min⁻¹), •step 4: ramp from 140° C. to 25° C. (10° C. min⁻¹), •step 5: ramp from 25° C. to 140° C. (10° C. min⁻¹). The glass transition temperatures (Tg) of the PS that are reported in Table 2 (Example 1 and 2) are determined in step 5 (ramp 25° C. to 140° C. at 10° C. min⁻¹).

2-2—The thermograms of the polystyrene homopolymers (Example 3, 4, 5, 6 and 7) are obtained according to the following programme: •step 1: ramp from 25° C. to 150° C. (10° C. min⁻¹), •step 2:1 min isotherm at 150° C., •step 3: ramp from 150° C. to 25° C. (10° C. min⁻¹), •step 4:3 min isotherm at 25° C., •step 5: ramp from 25° C. to 150° C. (10° C. min⁻¹). The glass transition temperatures (Tg) of the PS that are reported in Table 2 (Examples 4, 5, 6 and 7) are determined in step 5 (ramp 25° C. to 150° C. at 10° C. min⁻¹).

2-3—The thermograms of the PS-b-EBR diblock polymers (Example 1 and 2) are obtained according to the following programme: •step 1: ramp from 25° C. to 180° C. (10° C. min⁻¹), •step 2:5 min isotherm at 180° C., •step 3: ramp from 180° C. to −80° C. (10° C. min⁻¹), •step 4:5 min isotherm at −80° C., •step 5: ramp from −80° C. to 180° C. (10° C. min⁻¹), •step 6:5 min isotherm at 180° C., •step 7: ramp from 180° C. to −80° C. (10° C. min⁻¹), •step 8:5 min isotherm at −80° C., •step 9: ramp from −80° C. to 180° C. (10° C. min⁻¹). The glass transition temperatures (Tg) of the EBR and PS blocks that are reported in Table 2 (Examples 1 and 2) are determined in step 9 (ramp −80° C. to 180° C. at 10° C. min⁻¹).

2-4—The thermograms of the PS-b-EBR-b-PE triblock polymers (Example 3, 4, 5, 6 and 7) are obtained according to the following programme: •step 1: ramp from 25° C. to 180° C. (10° C. min 1), •step 2:1 min isotherm at 180° C., •step 3: ramp from 180° C. to −80° C. (10° C. min⁻¹), •step 4:3 min isotherm at −80° C., •step 5: ramp from −80° C. to 180° C. (10° C. min⁻¹), •step 6:1 min isotherm at 180° C., •step 7: ramp from 180° C. to −80° C. (20° C. min⁻¹), •step 8:3 min isotherm at −80° C., •step 9: ramp from −80° C. to 180° C. (20° C. min⁻¹). The glass transition temperatures (Tg) and the melting temperatures (Tf) of the EBR and PE blocks that are respectively reported in Table 2 (Example 4, 5, 5′, 6 and 7) are determined in step 5 (ramp −80° C. to 180° C. at 10° C. min⁻¹). The crystallization temperatures (Tc) of the PE blocks that are reported in Table 2 (Examples 3, 4, 5, 6 and 7) are determined in step 3 (ramp 180° C. to −80° C. at 10° C. min⁻¹).

The glass transition temperatures of the triblock polymers according to the invention that correspond to the Tg of the polystyrene block and to the Tg of the central block are determined according to the protocol described in paragraph 2-2 and in paragraph 2-3, respectively.

The melting temperatures (Tf) and crystallization temperatures (Tc) of the triblock polymers according to the invention that correspond to those of the central blocks and of the polyethylene blocks are determined according to the protocol described in paragraph 2-4.

The values of Tg and of Tf and of Tc are determined by applying the data reprocessing of the STARe software from Mettler Toledo which is based on the tangent method for the determination of the Tg as described in Standard ASTM 3418, the value of the Tg corresponding to the point designated by the well-known term “mid-point”. The melting temperature (Tm) corresponds to the tip of the melting peak.

### 3—Tensile Tests and Elastic Recovery Cycles:

The applications of tension are performed on an MTS Criterion C42 apparatus at the temperature of the analysis room (20-25° C.), equipped with a 50 N sensor and at a crosshead speed of 500 mm/min. The materials are pressed at 150° C. under 4/5 tonnes in a mould of 80 mm*60 mm*1.5 mm. Standardized H2-type test specimens (dimensions of use 30 mm×4 mm) are cut out at room temperature with an appropriate hollow punch.

The elastic recovery test makes it possible to quantify the sensitivity of the polymers to permanent deformation after deformation or after repeated cycles of deformation. An elastic recovery cycle consists in subjecting a test specimen to tension at a crosshead speed of 500 mm/min up to 300% maximum nominal deformation (δₘₐₓ), and then removing the stress for 10 minutes, following which the residual deformation (δi) of the test specimen is measured in percent. The test specimen is subjected to 9 recovery cycles. The elastic recovery ε_{recov} is calculated after each recovery cycle from the relationship ε_{recov}=(δₘₐₓ−δi)/δₘₐₓ.

### 4—Syntheses

All the reactions that are sensitive to air and/or humidity are performed under an argon atmosphere.

The dry polymerization solvents (toluene, methylcyclohexane and cyclohexane) are taken from the solvent fountain (SPS800 MBraun).

The 2-bromomesitylene (Sigma-Aldrich) is stored over molecular sieve (3 Å).

The methyltetrahydrofuran (MeTHF) is distilled over Na/benzophenone.

The ethyl tetrahydrofurfuryl ether (ETE) is passed over activated alumina and then diluted in toluene to obtain a solution at 0.3 mol 1-1 (stored over molecular sieve).

The styrene (Sigma-Aldrich) is dried over CaH₂ for 24 h under an argon atmosphere and then distilled under vacuum. The n-butyllithium (1.6 M in hexane, Sigma-Aldrich) is used as received.

The MMB (2-mesitylmagnesium bromide, 1 M in Et₂O, Sigma-Aldrich) is used as received.

The metallocene, in this case the {Me₂Si(C₁₃H₈)₂Nd(BH₄)₂Li(THF)}₂ complex, is prepared according to the protocol described in patent application WO 2007054224 A2.

The ethylene (N35 grade, Air Liquide) is used without purification.

The 1,3-butadiene is purified on an “Axens” alumina purification column before its use.

The 2,2′-methylenebis(6-tert-butyl-4-methylphenol) (bi-BHT, Sigma-Aldrich) is used as received as antioxidant.

The acetone and the methanol (technical grade) are used to precipitate the polymers.

The designation EBR is used to denote a statistical copolymer of ethylene and of 1,3-butadiene.

### Example 1: Synthesis of a PS-b-EBR Diblock Polymer

Step 1: Anionic polymerization of styrene and transmetallation (PS-MgMes). 40 ml of cyclohexane (mₛₒₗᵥₑₙₜ/mₘₒₙₒₘₑᵣ ratio=7), 5 g of styrene (dried over CaH₂ and distilled) and 0.166 ml (0.05 mmol, 0.2 equivalent) of ETE (0.3 M in toluene and stored over molecular sieve) are introduced into a conditioned Schlenk tube (3 vacuum-argon cycles). 0.156 ml (0.25 mmol, 1 equivalent) of n-BuLi (1.6 M in hexane) is added last to start the polymerization. The solution turns dark orange. The reaction medium is stirred at 40° C. for 20 min to reach 100% conversion. The transmetallation reaction is carried out with addition of 0.3 ml (0.3 mmol, 1.2 equivalent) of MMB to obtain an organomagnesium compound of formula (II) in which A is a polystyrene (PS) and R is the mesityl group (Mes). The medium is subsequently transferred using a cannula under an argon stream into the reactor that has previously been conditioned and heated to 90° C.

Step 2: Formation of the PS-b-EBR diblock polymer. 32.7 mg (51 μmol) of the Nd {Me₂Si(C₁₃H₈)₂Nd(BH₄)₂Li(THF)}₂ complex is weighed in a glovebox into a 50 ml flask. 160 ml of toluene is taken from the solvent fountain into a 250 ml flask. 0.2 ml (0.2 mmol) of MMB(Et₂O) is added to the toluene. The solution (toluene+MMB) is stirred for 5 min and then the Nd {Me₂Si(C₁₃H₈)₂Nd(BH₄)₂Li(THF)}₂ complex is added. The solution is transferred using a cannula under an argon stream into the reactor that already contains the PS-MgMes solution. The reactor is isolated and the pressure is reduced to 0.5 bar using a vacuum pump before starting the stirring (1000 rpm). The reactor is then pressurized to 4 bar with an ethylene/butadiene mixture with a molar ratio of 80/20. The pressure is kept constant in the reactor by means of a tank containing the ethylene/butadiene mixture and the polymerization is carried out at 90° C. The monomer consumption is monitored by the drop in pressure in the tank until the consumption of 15 g of the ethylene/butadiene mixture is reached. The reactor is then depressurized and degassed carefully under an argon stream and the medium is deactivated by addition of EtOH (about 0.5 ml) and then cooled to ambient temperature. 0.2 g of 2,2′-methylenebis(6-tert-butyl-4-methylphenol) (di-BHT) antioxidant is added and the copolymer is precipitated in 600 ml of MeOH and then is recovered in a crystallizing dish and dried under vacuum at 80-100° C. for 6 h. The PS-b-EBR diblock polymer is weighed and analysed by SEC-THF and DSC.

### Example 2: Synthesis of a PS-b-EBR Diblock Polymer

The same experimental conditions as for Example 1 are used except for the amount of styrene (7.5 g), cyclohexane (67 ml) and toluene (133 ml). The polymerization time of the styrene is also increased to 30 min.

### Example 3: Synthesis of a PS-b-EBR-b-PE Triblock Polymer

Step 1: Anionic polymerization of styrene and transmetallation (PS-MgMes). 13.5 ml of cyclohexane (mₛₒₗᵥₑₙₜ/mₘₒₙₒₘₑᵣ ratio=7), 1.5 g of styrene (dried over CaH₂ and distilled) and 0.166 ml (0.05 mmol, 0.2 equivalent) of ETE (0.3 M in toluene and stored over molecular sieve) are introduced into a conditioned Schlenk tube (3 vacuum-argon cycles). 0.156 ml (0.25 mmol, 1 equivalent) of n-BuLi (1.6 M in hexane) is added last to start the polymerization. The solution turns dark orange. The reaction medium is stirred at 40° C. for 10 min to reach 100% conversion. The transmetallation reaction is carried out with addition of 0.3 ml (0.3 mmol, 1.2 equivalent) of MMB to obtain an organomagnesium compound of formula (II) in which A is a polystyrene (PS) and R is the mesityl group (Mes). The medium is subsequently transferred using a cannula under an argon stream into the reactor that has previously been conditioned and heated to 90° C.

Step 2: Formation of the PS-b-EBR-PE triblock polymer. 32 mg (50 μmol) of the Nd {Me₂Si(C₁₃H₈)₂Nd(BH₄)₂Li(THF)}₂ complex is weighed in a glovebox into a 50 ml flask. 186.5 ml of toluene is taken from the solvent fountain into a 250 ml flask. 0.2 ml (0.2 mmol) of MMB is added to the toluene. The solution (toluene+MMB(Et₂O))) is stirred for 5 min and then the Nd {Me₂Si(C₁₃H₈)₂Nd(BH₄)₂Li(THF)}₂ complex is added. The solution is transferred using a cannula under an argon stream into the reactor that already contains the PS-MgMes solution. The reactor is isolated and the pressure is reduced to 0.5 bar using a vacuum pump before starting the stirring (1000 rpm). The reactor is then pressurized to 4 bar with an ethylene/butadiene mixture with a molar ratio of 80/20. The reaction medium is brought to and kept at the temperature of 90° C. The pressure is kept constant in the reactor by means of a tank containing the ethylene/butadiene mixture. The monomer consumption is monitored by the drop in pressure in the tank until consumption of 15 g of the ethylene/butadiene mixture. The reactor is then isolated and the remaining monomers are consumed until the pressure reaches 2.5 bar to obtain the EBR copolymer with the desired Mn, and at the same time the tank is conditioned by 2 vacuum-ethylene cycles then pressurized with 100% ethylene. The reactor is then pressurized to 4 bar and fed with ethylene. After having consumed the amount of 1.5 g of ethylene, the reactor is depressurized and degassed carefully under an argon stream and the medium is deactivated by addition of EtOH (about 0.5 ml) and then cooled to ambient temperature. 0.2 g of 2,2′-methylenebis(6-tert-butyl-4-methylphenol) (di-BHT) antioxidant is added and the copolymer is precipitated in 600 ml of MeOH and then is recovered in a crystallizing dish and dried under vacuum at 80-100° C. for 6 h. The PS-b-EBR-b-PE triblock polymer is weighed and analysed by DSC.

### Example 4: Synthesis of the PS-b-EBR-b-PE Triblock Polymer

The same experimental conditions as for Example 3 were used except for the amount of styrene (2.5 g), cyclohexane (22.5 ml) and toluene (177.5 ml).

### Example 5: Synthesis of the PS-b-EBR-b-PE Triblock Polymer

The same experimental conditions as for Example 3 were used except for the amount of styrene (2.5 g), cyclohexane (22.5 ml) and toluene (177.5 ml).

### Example 6: Synthesis of the PS-b-EBR-b-PE Triblock Polymer

The same experimental conditions as for Example 3 were used except for the amount of styrene (3.75 g), cyclohexane (33.7 ml) and toluene (166.3 ml).

### Example 7: Synthesis of the PS-b-EBR-b-PE Triblock Polymer

The same experimental conditions as for Example 3 were used except for the amount of styrene (5 g), cyclohexane (45 ml) and toluene (155 ml).

The characteristics in relation to the macrostructure of the polymers are shown in Table 1. Mn exp are the number-average molar masses determined by the SEC analysis. Mn theo are the targeted number-average molar masses. Also shown in Table 1 are the amounts of polymers targeted (m_{copo} targeted) and those actually obtained experimentally (m_{copo} exp). D_{PS} and D_{copo} are respectively the dispersity of the polystyrene block and the dispersity of the copolymer.

The glass transition temperature (Tg), melting temperature (Tf) and crystallization temperature (Tc) of the polymers are shown in Table 2.

The elastic recovery results of the polymers are shown in Table 3.

The results show that the introduction of a polyethylene block according to the invention into a PS-b-EBR diblock polymer at the end of the EBR block so that the EBR block becomes the central block of the triblock polymer in accordance with the invention makes it possible to significantly increase the elastic recovery of the polymer.

In the tables, “nd” is an abbreviation for not determined.

TABLE 1

| | | Polystyrene (PS) | | Copolymer | | | | |
|---|---|---|---|---|---|---|---|---|
| | | Mn_{PS} | | m_{copo} | m_{copo} | Mn_{copo} | Mn_{copo} | |
| | | exp | | targeted | obtained | theo | exp | |
| Example | copolymer | (g/mol) | Ð_{PS} | (g) | (g) | (g/mol) | (g/mol) | Ð_{copo} |
| 1 | PS-b-EBR | 24 200 | 1.08 | 20 | 18.70 | 80 000 | 59 200 | 1.7 |
| 2 | PS-b-EBR | 37 300 | 1.05 | 22.5 | 23.82 | 90 000 | 90 500 | 1.6 |
| 3 | PS-b-EBR-b-PE | 7 800 | 1.09 | 18 | 18.00 | 72 000 | nd | nd |
| 4 | PS-b-EBR-b-PE | 10 700 | 1.07 | 19 | 19.50 | 76 000 | nd | nd |
| 5 | PS-b-EBR-b-PE | 15 000 | 1.05 | 19 | 17.65 | 76 000 | nd | nd |
| 6 | PS-b-EBR-b-PE | 24 100 | 1.06 | 20.25 | 20.75 | 81 000 | nd | nd |
| 7 | PS-b-EBR-b-PE | 36 400 | 1.05 | 21.50 | 21.50 | 86 000 | nd | nd |

TABLE 2

| | | Tg · (° C.) [symbol] | | Tf · | Tc · | [symbol] |
|---|---|---|---|---|---|---|
| Example [symbol] | Copolymer [symbol] | EBR [symbol] | PS [symbol] | (° C.) [symbol] | (° C.) [symbol] | [symbol] |
| 1 [symbol] | PS-b-EBR [symbol] | −32.7 [symbol] | 101.5 [symbol] | / [symbol] | / [symbol] | [symbol] |
| 2 [symbol] | PS-b-EBR [symbol] | −30.8 [symbol] | 104.8 [symbol] | / [symbol] | / [symbol] | [symbol] |
| 3 [symbol] | PS-b-EBR-b-PE [symbol] | −31.0 [symbol] | nd [symbol] | 115.0 [symbol] | 68.0 [symbol] | [symbol] |
| 4 [symbol] | PS-b-EBR-b-PE [symbol] | −29.0 [symbol] | nd [symbol] | 117.0 [symbol] | 77.0 [symbol] | [symbol] |
| 5 [symbol] | PS-b-EBR-b-PE [symbol] | −30.0 [symbol] | nd [symbol] | 115.0 [symbol] | 69.0 [symbol] | [symbol] |
| 6 [symbol] | PS-b-EBR-b-PE [symbol] | −32.0 [symbol] | nd [symbol] | 121.0 [symbol] | 83.0 [symbol] | [symbol] |
| 7 [symbol] | PS-b-EBR-b-PE [symbol] | −29.0 [symbol] | nd [symbol] | 121.0 [symbol] | 81.0 [symbol] | [symbol] |

TABLE 3

| | Copolymer/Recovery | | | | | | | | | |
|---|---|---|---|---|---|---|---|---|---|---|
| Example | cycle | 1^{st} | 2^{nd} | 3^{rd} | 4^{th} | 5^{th} | 6^{th} | 7^{th} | 8^{th} | 9^{th} |
| 1 | PS-b-EBR | 58.8 | 53.4 | 50 | 56.3 | nd | nd | nd | nd | nd |
| 2 | PS-b-EBR | nd | nd | nd | nd | nd | nd | nd | nd | nd |
| 3 | PS-b-EBR-b-PE | 93.5 | 92.1 | 91.3 | 90.7 | 90.3 | 89.8 | 89.6 | 89.3 | 89.1 |
| 4 | PS-b-EBR-b-PE | 93.7 | 92.7 | 92.2 | 91.8 | 91.5 | 91.3 | 91.1 | 91.9 | 91.8 |
| 5 | PS-b-EBR-b-PE | 98.2 | 97.6 | 96.8 | 96.4 | 96.1 | 95.8 | 95.3 | 95.2 | 94.7 |
| 6 | PS-b-EBR-b-PE | 87.5 | 85 | 83.8 | 82.9 | 82.3 | 81.7 | 81.3 | 80.8 | 80.4 |
| 7 | PS-b-EBR-b-PE | 86.3 | 84.6 | 83.7 | 83.2 | 82.8 | 82.6 | 82.3 | 82 | 81.8 |

What is claimed is:

1. A triblock polymer of formula A-B-C in which the symbol A represents a polystyrene block, the symbol B represents a statistical copolymer block with a glass transition temperature of less than −10° C., the statistical copolymer comprising units of a 1,3-diene and more than 50 mol % of ethylene units, and the symbol C represents a polyethylene block with a melting temperature of greater than 90° C.

2. The triblock polymer according to claim 1, in which the statistical copolymer block is a statistical copolymer of ethylene and of a 1,3-diene.

3. The triblock polymer according to claim 1, in which the statistical copolymer block contains more than 60 mol % of ethylene units.

4. The triblock polymer according to claim 1, in which the statistical copolymer block contains less than 90 mol % of ethylene units.

5. The triblock polymer according to claim 1, in which the statistical copolymer block contains at most 85 mol % of ethylene units.

6. The triblock polymer according to claim 1, in which the portion of polystyrene block and of polyethylene block in the triblock polymer represents less than 50% by mass of the mass of the triblock polymer.

7. The triblock polymer according to claim 1, in which the statistical copolymer block has a glass transition temperature of between-90° C. and −10° C.

8. The triblock polymer according to claim 1, in which the statistical copolymer block has a number-average molar mass of greater than 20 000 g/mol, preferentially greater than or equal to 50 000 g/mol.

9. The triblock polymer according to claim 1, in which the 1,3-diene is 1,3-butadiene or isoprene or else a mixture of 1,3-dienes of which one is 1,3-butadiene, preferably 1,3 butadiene.

10. The triblock polymer according to claim 1, in which the 1,3-diene is 1,3-butadiene or a mixture of 1,3-dienes of which one is 1,3-butadiene, and the statistical copolymer block contains 1,2-cyclohexane units or 1,4-cyclohexane units.

11. The triblock polymer according to claim 1, in which the polystyrene block has a number-average molar mass of greater than or equal to 5000 g/mol.

12. The triblock polymer according to claim 1, in which the polyethylene block has a number-average molar mass of greater than or equal to 2000 g/mol and less than or equal to 12 000 g/mol.

13. The triblock polymer according to claim 1, which triblock polymer is a thermoplastic elastomer.

14. A composition which comprises a triblock polymer according to claim 1 and another component.

15. A process for synthesizing the triblock polymer of formula A-B-C as defined in claim 1, which process comprises, in the presence of a catalytic system based on at least one metallocene of formula (I) and on an organomagnesium compound of formula (II), the statistical copolymerization of a monomer mixture containing ethylene and a 1,3-diene, followed by the homopolymerization of ethylene, 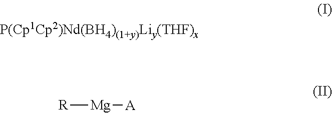
Cp¹ and Cp², which are identical or different, being selected from the group consisting of cyclopentadienyl groups and fluorenyl groups, it being possible for the groups to be substituted or unsubstituted,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms,
y, which is an integer, being equal to or greater than 0,
x, which is or not an integer, being equal to or greater than 0,
R comprising a benzene ring of which two carbon atoms are substituted, one of the two is substituted by a methyl, an ethyl or an isopropyl or forms a ring with the carbon atom which is its closest neighbour, the second carbon atom being substituted by a methyl, an ethyl or an isopropyl, the magnesium atom being in ortho position relative to each of said two carbon atoms,
A representing a polystyrene block,
B representing a statistical copolymer block with a glass transition temperature of less than-10° C., the statistical copolymer comprising units of a 1,3-diene and more than 50 mol % of ethylene units,
C representing a polyethylene block with a melting temperature of greater than 90° C.

16. The triblock polymer according to claim 3, in which the statistical copolymer block contains at least 70 mol % of ethylene units.

17. The triblock polymer according to claim 6, in which the portion of polystyrene block and of polyethylene block in the triblock polymer represents from 15% to 40% by mass of the mass of the triblock polymer.

18. The triblock polymer according to claim 7, in which the statistical copolymer block has a glass transition temperature of between −70° C. and −20° C.

19. The triblock polymer according to claim 18, in which the statistical copolymer block has a glass transition temperature of between −50° C. and −20° C.

20. The triblock polymer according to claim 8, in which the statistical copolymer block has a number-average molar mass of greater than or equal to 50 000 g/mol.

21. The triblock polymer according to claim 9, in which the 1,3-diene includes 1,3-butadiene.

22. The triblock polymer according to claim 10, in which the statistical copolymer block contains 1,2-cyclohexane units.

23. The triblock polymer according to claim 11, in which the polystyrene block has a number-average molar mass ranging from 5000 g/mol to 100 000 g/mol.

24. The triblock polymer according to claim 15, in which R¹ and R² each represent a methyl.
